(19) United States
(12) Patent Application Publication
(10) Pub. No.: US 2011/0036144 A1
(43) Pub. Date: Feb. 17, 2011

(54) METHOD AND DEVICE FOR REGENERATING A PARTICLE FILTER HAVING AN EXHAUST GAS PROBE SITUATED IN THE EXHAUST GAS DUCT DOWNSTREAM THEREOF

(75) Inventors: Eduard Weiss, Utergruppenbach (DE); Dimitrios Stavrianos, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/851,145

(22) Filed: Aug. 5, 2010

(30) Foreign Application Priority Data
Aug. 5, 2009 (DE) 10 2009 028 237.8

(51) Int. Cl. G01N 7/00

(52) U.S. Cl. 73/23.2

(57) ABSTRACT

The invention relates to a method for monitoring and controlling the regeneration of a particle filter in an exhaust gas duct of an internal combustion engine, wherein said regeneration of the particle filter takes place by means of an oxidative burning off of particles during a regeneration phase. Provision is made according to the invention for the internal combustion engine to be operated at a lean operating point at least intermittently during lean operating phases or during a mixture oscillation and for the regeneration of the particle filter to be monitored during the lean operating phases or during the mixture oscillation via the temporal course of a second signal of a second lambda probe disposed in the exhaust gas direction downstream of said particle filter or of a second parameter derived therefrom in comparison to the temporal course of a first signal of a first lambda probe disposed in the exhaust gas direction upstream of said particle filter or of a first parameter derived therefrom. The invention also relates to a corresponding device. During the lean operating phases or the mixture oscillation, the first lambda probe disposed upstream of the particle filter emits a signal for a correspondingly lean lambda value. Oxygen is consumed from the exhaust gas by means of the oxidative burning off of particles in the particle filter. The oxygen concentration in the exhaust gas downstream of the particle filter is therefore lower than upstream of said particle filter. For that reason, the second lambda probe disposed downstream of said particle filter emits a signal for a richer lambda value in comparison to the first lambda probe during the lean operating phases or during the mixture oscillation. If the burn-off of particles has ended, the difference between the signals of the first and second lambda probe disappears.

This application claims benefit of Serial No. 10 2009 028 237.8, filed 5 Aug. 2009 in Germany and which application is incorporated herein by reference. To the extent appropriate, a claim of priority is made to the above disclosed application.

### BACKGROUND

The invention relates to a method for monitoring and controlling the regeneration of a particle filter in an exhaust gas duct of an internal combustion engine, wherein said regeneration of the particle filter occurs by means of an oxidative burning off of particles during a regeneration phase.

The invention furthermore relates to a device for monitoring and controlling the regeneration of a particle filter in an exhaust gas duct of an internal combustion engine, the regeneration of the particle filter taking place by means of an oxidative burning off of particles during a regeneration phase and the control of the regeneration of said particle filter taking place via a control unit.

Particle filters are used in the exhaust gas duct of internal combustion engines for reducing the particle emissions of diesel engines and increasingly in the future also of Otto engines (threshold values according to EU6 from 2014 on). The exhaust gas is led through the particle filter, which removes the solid particles located in the exhaust gas and retains them in a filter substrate. Said particle filter clogs with time from the masses of soot deposited in the filter substrate. This clogging becomes apparent by an increase in the exhaust gas back pressure, which has a negative effect on the engine performance and the fuel consumption. The deposited mass of soot must for this reason be discharged from time to time. This filter regeneration occurs during separate regeneration phases via an oxidative burning off of the particles, which takes place independently as an exothermic reaction provided that an exhaust temperature of at least 580EC and a sufficiently high oxygen concentration are present in the exhaust gas. The course of the regeneration can be controlled via the composition of the exhaust gas and the exhaust gas temperature.

Besides the particle filter, the exhaust gas aftertreatment of internal combustion engines requires further components. The pollutants: hydrocarbons, carbon monoxide and nitrogen oxides are thus converted via a three-way catalytic converter in Otto engines, which are operated according to a homogenous combustion concept. In the case of lean combustion concepts, a storage catalytic converter for nitrogen oxides is usually downstream of said three-way catalytic converter. A lowest possible pollutant emission is achieved by a lambda control, wherein the air/fuel mixture supplied to the internal combustion engine is controlled on the basis of the oxygen concentration present in the exhaust gas. The proportion of oxygen present in the exhaust gas is described by a lambda value, which receives the value of 1 for a stoichiometric combustion, a value>1 when oxygen is in excess and a value<1 when there is an oxygen deficiency. Lambda is measured by corresponding lambda probes, which are disposed in the exhaust gas duct.

The regeneration of a particle filter can be initiated when a predetermined threshold value for the exhaust gas backpressure has been exceeded. Because an excess of oxygen must be present in the exhaust gas for a burning off of the particles to take place, the mixture composition of the internal combustion engine can not be freely selected in this phase according to the requirements of the driving operation. It is therefore desirable to determine an end of the regeneration in order to be able to convert to a normal driving operation.

It is therefore the aim of the invention to provide a method, which makes a reliable closed-loop control and determination of the end of the regeneration of a particle filter possible without giving rise to costs for additional components.

It is furthermore the aim of the invention to provide a corresponding device for carrying out the method.

### SUMMARY

The aim of the invention relating to the method is thereby met by virtue of the fact that during the regeneration phase of the particle filter, the internal combustion engine is operated at least intermittently during lean operating phases or during a mixture oscillation at a lean operating point and by the fact that the regeneration of the particle filter is monitored during the lean operating phases or during the mixture oscillation via the temporal course of a second signal of a second lambda probe disposed in the exhaust gas direction downstream of the particle filter or of a second parameter derived therefrom in comparison to the temporal course of a first signal of a first lambda probe disposed in the exhaust gas direction upstream of the particle filter or of a first parameter derived therefrom.

The regeneration of the particle filter occurs after starting the regeneration phase via an oxidative burning off of the deposited particles, which takes place independently as an exothermic reaction provided the exhaust gas temperature is sufficiently high and a sufficiently high oxygen concentration is present in the exhaust gas.

Exhaust gas having an oxygen concentration sufficiently high for the regeneration is supplied to the particle filter by means of an at least intermittent operation of the internal combustion engine at a lean operating point during the lean operating phases or during the mixture oscillation. During these lean operating phases, the first lambda probe disposed upstream of the particle filter emits a signal for a corresponding lean lambda value. In the case of a mixture oscillation, said first lambda probe indicates the temporal course of the oxygen concentration upstream of the particle filter.

Oxygen from the exhaust gas is consumed by the oxidative burning off of particles in the particle filter. The oxygen concentration of the exhaust gas after the particle filter is thereby less than that before said particle filter. For that reason, the second lambda probe disposed downstream of said particle filter emits a signal for a richer lambda value during the lean operating phases in comparison to the first lambda probe. During a mixture oscillation, the second lambda probe exhibits a signal for a richer lambda value during the lean periods.

How markedly different the lambda of the exhaust gas and thereby the signals of the two lambda probes are upstream and downstream of said particle filter during the lean operating phases or the mixture oscillation, depends on the loading of the particle filter. A high level of particle loading at a sufficient exhaust gas temperature leads to a high oxygen requirement. At a lower level of particle loading, less oxygen is converted. If at the beginning of regeneration of the particle filter the difference in the lambda is still very large, the lambda of the exhaust gas after the particle filter then approaches the lambda of the exhaust gas before said particle filter as the regeneration progresses. The course of the regeneration of the particle filter can therefore be suggested from the temporal course of the second signal of the second lambda probe disposed downstream of said particle filter in comparison to the first signal of the first lambda probe disposed upstream of said particle filter during the lean operating phases or during the mixture oscillation or by the comparison of the parameters derived from said signals. The regeneration can be correspondingly monitored and its course controlled.

An advantage of the method is that it accesses existing sensor concepts by the use of lambda probes. If lambda probes are already provided in the exhaust gas duct of the internal combustion engine for the lambda control of said internal combustion engine, their signals can thus be used for the open-loop and closed-loop control of the regeneration of the particle filter whereby said method is cost effectively implemented.

If the particles are burned as far as possible, oxygen is no longer converted in the particle filter. The oxygen concentration before and after said particle filter and hence the signals of the two lambda probes are then approximately equal. Provision can therefore be made for the regeneration phase of the particle filter to end if the second signal of the second lambda probe corresponds to the first signal of the first lambda probe within a predetermined tolerance during the lean operating phase or the mixture oscillation or if the second parameter derived from said second signal corresponds to the first parameter derived from said first signal within a predetermined tolerance.

Provision can be made corresponding to a particularly preferred modification to the embodiment of the invention for the air/fuel mixture supplied to the internal combustion engine to be periodically changed during the regeneration phase by means of the mixture oscillation such that an oxygen rich exhaust gas arises in the exhaust gas before the particle filter.

In so doing, provision can furthermore be made for the air/fuel mixture supplied to the internal combustion engine to be periodically changed during the regeneration phase by means of the mixture oscillation such that a periodic change of lambda about the value: lambda=1 results in the exhaust gas before the particle filter.

A sufficient amount of oxygen is supplied to the particle filter for the regeneration by means of the mixture oscillation, for example about lambda=1 from lambda=0.98 to lambda=1.04. The temporal course of the regeneration can be monitored by comparing the flow of the second signal or the second parameter derived therefrom with that of the first signal or the first parameter derived therefrom. As the regeneration of the particle filter progresses, the signal of the second lambda probe thereby conforms to the signal of the first lambda probe at least during the lean periods of the mixture oscillation.

If provision is made for a first lambda value of a first wideband lambda probe disposed upstream of the particle filter to be used as the first signal and for a second lambda value of a second wideband lambda probe disposed downstream of said particle filter or of a two-point lambda probe to be used as the second signal, lambda probes disposed in the exhaust gas duct can then be used.

Corresponding to an alternative modification to the embodiment of the invention, provision can be made for a first probe voltage of a first two-point lambda probe disposed upstream of the particle filter to be used as the first signal and for a second probe voltage of a two-point lambda probe disposed downstream of said particle filter to be used as the second signal. The use of two-point lambda probes allows for a cost effective implementation of the method. During a mixture oscillation with a corresponding oscillation of the lambda value, the first two-point lambda probe emits a periodically oscillating signal between 200 mV and 600 mV. As long as the particles are being burned off in the particle filter, the second two-point lambda probe emits a signal of 600 mV. After burn-off of the particles has taken place, its signal also oscillates between 200 mV and 600 mV.

A disposal of a two-point lambda probe disposed before of the particle filter and a wideband lambda probe disposed after the particle filter is likewise conceivable; however, is not advantageous for reasons of cost.

The aim of the invention relating to the device is thereby met as a result of a first lambda probe being disposed in the exhaust gas duct in the exhaust gas direction before the particle filter and a second lambda probe being disposed in said exhaust gas direction after said particle filter and by the fact that a first signal of the first lambda probe and a second signal of the second lambda probe are supplied to the control unit and by the fact that a first program routine is provided in the control unit for comparing said second signal or a second parameter derived therefrom with said first signal or a first parameter derived therefrom during the lean operating phases provided in the regeneration phase or during a mixture oscillation of the internal combustion engine.

Oxygen from the exhaust gas is consumed in the particle filter during the regeneration as a result of the oxidative burning off of the particles. A correspondingly richer lambda arises downstream of said particle filter as a function of the current particle load of said particle filter than upstream of said particle filter during lean operating phases of the internal combustion engine, just as said phases also arise in a lean period during a mixture oscillation. By comparing the signal of a second lambda probe disposed downstream of said particle filter with the signal of a first lambda probe disposed upstream of said particle filter, the loading condition of said particle filter can therefore be suggested during the regeneration and the regeneration process can be correspondingly monitored.

A simple evaluation of the signals of the lambda probes can be achieved as a result of a second program routine being provided in the control unit for the mixture oscillation resulting from a periodic change in the fuel mixture supplied to the internal combustion engine during the regeneration phase. A periodic change of lambda, preferably about a value of lambda=1, is brought about at the first lambda probe upstream of the particle filter by the mixture oscillation. During the lean periods of the mixture oscillation, said first lambda probe indicates a lambda>1. As a result of the consumption of the oxygen, the second lambda probe indicates a lower lambda value in comparison to the first lambda probe. The course of the regeneration of said particle filter can therefore be suggested from the signal flow of said second lambda probe in comparison with the signal of said first lambda probe across consecutive lean periods.

The method or the device is advantageously used for regeneration of a particle filter provided in an exhaust gas duct of a diesel engine or an Otto engine.

### BRIEF DESCRIPTION OF THE DRAWINGS

The invention is explained below in detail using an exemplary embodiment depicted in the figures. The following are shown:

FIG. 1 is an internal combustion engine having a particle filter disposed in its exhaust gas duct and a three-way catalytic converter disposed downstream thereof,

FIG. 2 is a signal flows during a regeneration of the particle filter when using wideband lambda probes in the exhaust gas duct,

FIG. 3 is a signal flows during a regeneration of the particle filter when using two-point lambda probes in the exhaust gas duct,

FIG. 4 is a signal flows during a regeneration of the particle filter during a lean operating phase of the internal combustion engine.

### DETAILED DESCRIPTION

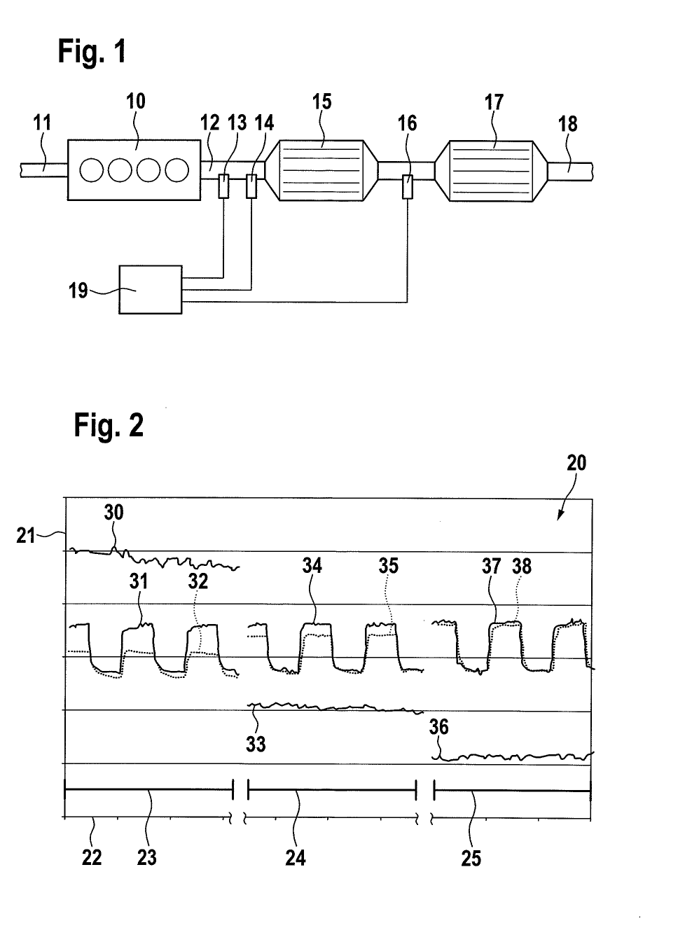

FIG. 1 shows an internal combustion engine 10 having an air supply 11 and a particle filter 15 disposed in an exhaust gas duct 12 as well as a three-way catalytic converter 17 disposed downstream thereof. The exhaust gas of the internal combustion engine 10 purified in the particle filter 15 and the three-way catalytic converter 17 is discharged via an exhaust gas outlet 18. The lambda value of the exhaust gas in the exhaust gas duct 12 is determined by means of a lambda probe 13 situated directly behind said internal combustion engine 10. The temperature of the exhaust gas is additionally determined in this region by means of a temperature probe 14. Particles are deposited in said particle filter 15 during the operation of said internal combustion engine 10. These soot deposits increase the exhaust gas backpressure. Said soot deposits in said particle filter 15 must therefore when necessary be burned off, and in this way said particle filter 15 is regenerated. A regeneration can only take place if the exhaust gas temperature lies above approximately 580EC, which can be established with the temperature probe 14. Furthermore, sufficient oxygen must be available for a burn-off operation. This can be determined with the first lambda probe 13. A second lambda probe 16 is disposed in the exhaust gas duct 12 downstream of said particle filter 15. From the difference in the output signals of said first lambda probe 13 and said second lambda probe 16, it can be determined to what extent the burn-off of particles in said particle filter 15 consumes oxygen. If no difference can be established between the signals, the burn-off is completed. The signals of said first lambda probe 13 and said second lambda probe 16 as well as the output signal of the temperature probe 14 are supplied to a control unit 19. A program sequence is provided in the control unit 19 for comparing the signals and for controlling the regeneration.

FIG. 2 shows a diagram with signal flows during the regeneration of the particle filter 15 if the first lambda probe 13 and the second lambda probe 16 are embodied as wideband lambda probes. The signals are plotted along a first signal axis 21 and a first time axis 22. A first regeneration phase 23, a second regeneration phase 24 and a third regeneration phase 25, which follow one another in a temporally separated manner during a regeneration of said particle filter 15, are designated along the first time axis 22.

In the exemplary embodiment depicted, an oscillation of the lambda value about the value: lambda=1 is caused during the regeneration of the particle filter 15 by a mixture oscillation of the air/fuel ratio supplied to the internal combustion engine. During the first regeneration phase 23, shortly after the start of the regeneration of said particle filter 15, the exhaust gas backpressure in a first pressure signal section 30 is still comparatively high and lies in a range of 100 mbar. Said exhaust gas backpressure drops slightly in the first pressure signal section 30 as a result of the burning off of particles. A first section of a first lambda signal 31 shows the fluctuations in the oxygen concentration, which are caused by the mixture oscillation, at the location of the first lambda probe 13 during the first regeneration phase 23. A first section of a second lambda signal 32 shows the fluctuations of the oxygen concentration at the location of the second lambda probe 16 downstream of said particle filter 15 during said first regeneration phase 23. The amplitude of the first section of the first lambda signal 31 is considerably larger than that of the first section of the second lambda signal 32 on account of the consumption of oxygen during the burn-off operation.

At a later point in time of the regeneration, in the second regeneration phase 24, the particle filter 15 is partially regenerated and the exhaust gas backpressure in a second pressure signal section 33 lies in a range of approximately 40 mbar. A second section of the first lambda signal 34 indicates the fluctuations in the oxygen concentration at the location of the first lambda probe 13, which is unchanged with respect to the first section of the first lambda signal 31. A second section of the second lambda signal 35 indicates an increased amplitude with respect to the first section of said second lambda signal 32, said increased amplitude reaching approximately the amplitude of said second section of the first lambda signal 34. This indicates that the burn-off of particles is reduced and that the regeneration can be ended shortly.

In the third regeneration phase 25, the particle filter 15 is completely regenerated and the exhaust gas backpressure in a third pressure signal section 36 lies in a range of 20 mbar. A third section of the first lambda signal 37 indicates the fluctuations in the oxygen concentration at the location of the first lambda probe 13, which is unchanged with respect to the first section of the first lambda signal 31. A third section of the second lambda signal 38 indicates an increased amplitude with respect to the first section of the second lambda signal 32 and the second section of the second lambda signal 35, which is practically identical to the amplitude of the third section of said first lambda signal 37. This indicates that a burn-off of particles is no longer taking place and that the regeneration can be ended.

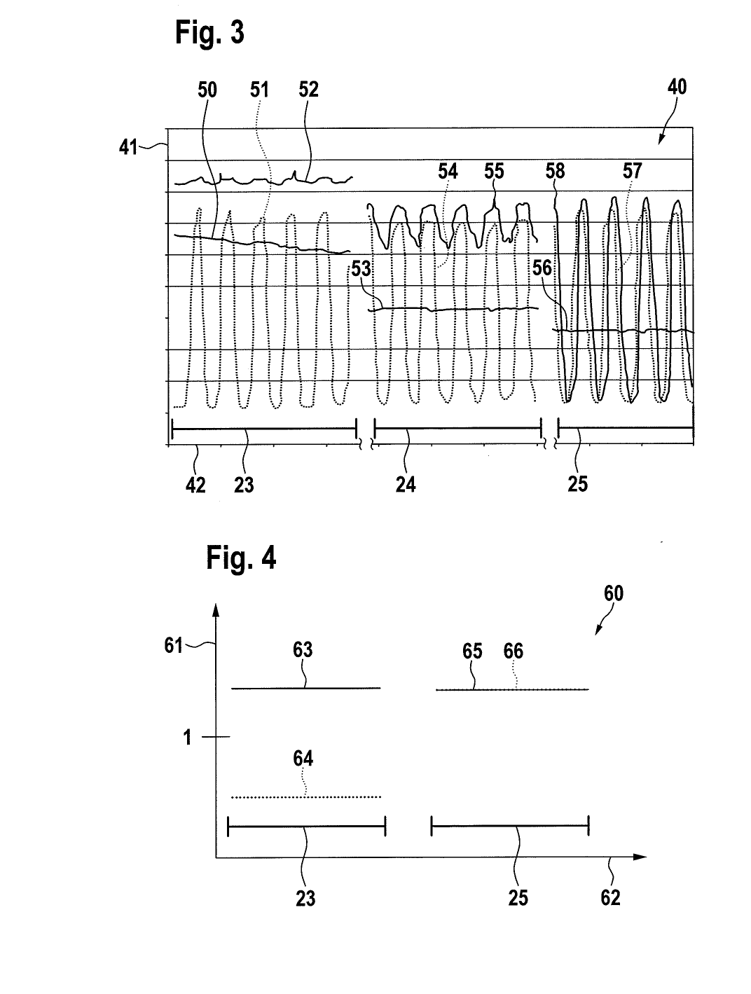

FIG. 3 shows a diagram 40 with signal flows during the regeneration of a particle filter 15 if the first lambda probe 13 and the second lambda probe 16 are embodied as two-point lambda probes. The signals are plotted along a second signal axis 41 and a second time axis 42. The first regeneration phase 23, the second regeneration phase 24 and the third regeneration phase 25, which were already introduced in FIG. 1, are designated along the second time axis 42.

During the first regeneration phase 23, shortly after the start of the regeneration of the particle filter 15, the exhaust gas backpressure is comparatively high in a fourth pressure signal section 50 and lies in a range of 100 mbar. The exhaust gas backpressure drops slightly in the fourth pressure signal section 50 due to the burning off of particles. The composition of the air/fuel mixture of the internal combustion engine 10 is also controlled in this exemplary embodiment such that the lambda value of the exhaust gas upstream of said particle filter 15 periodically fluctuates around the stoichiometric composition of 1. A first section of a second lambda signal 51 shows the fluctuations of the oxygen concentration at the location of the first lambda probe 13 during said first regeneration phase 23. A second section of a fourth lambda signal 52 shows the oxygen concentration at the location of the second lambda probe 16 downstream of said particle filter 15 during said first regeneration phase 23. Due to the consumption of oxygen during the burn-off operation, the signal of the second lambda probe 16 lies in the rich range in the first section of the fourth lambda signal 52.

At a later point in time of the regeneration, in the second regeneration phase 24, the particle filter 15 is partially regenerated and the exhaust gas backpressure lies in a range of approximately 40 mbar in a fifth pressure signal section 53. A second section of the third lambda signal 54 indicates the fluctuations in the oxygen concentration at the location of the first lambda probe 13, which is unchanged with respect to the first section of the third lambda signal 51. A second section of the fourth lambda signal 55 indicates an increased amplitude with respect to the first section of the fourth lambda signal 52; said signal drops altogether out of the rich range. This indicates that the burn-off of particles is reduced and that the regeneration can be ended shortly.

In the third regeneration phase 25, the particle filter 15 is completely regenerated and the exhaust gas backpressure lies in a range of 20 mbar in a sixth pressure signal section 56. A third section of the third lambda signal 57 indicates the fluctuations in the oxygen concentration at the location of the first lambda probe 13, which is unchanged with respect to the first section of the third lambda signal 51. A third section of the fourth lambda signal 58 indicates an increased amplitude with respect to the first section of the fourth lambda signal 52 and the second section of the fourth lambda signal 55, which is practically identical to the amplitude of the third section of the third lambda signal 57. This indicates that a burning off of particles is no longer taking place and that the regeneration of said particle filter 15 can be ended.

In FIG. 4 the output signals of the first lambda probe 13 and the second lambda probe 16 depicted in FIG. 1 are plotted in a third diagram 60 along a third time axis 62 and a third signal axis 61 during the first regeneration phase 23 and the third regeneration phase 25 when a regeneration of the particle filter 15 is taking place in a lean operating phase during operation of the internal combustion engine 10. During a lean operating phase of this type, the lambda value of the exhaust gas is set to a lambda value above 1, by way of example to lambda=1.05. A first section of a fifth lambda signal 63 reflects the position of the output signal of said first lambda probe 13 at the beginning of the regeneration in said first regeneration phase 23 at a value above lambda=1, by way of example at lambda=1.05. A first section of a sixth lambda signal 64 reflects the position of the output signal of the second lambda probe 16. In said first regeneration phase 23, oxygen is consumed by the burning off of soot particles in said particle filter 15, and the lambda value of the exhaust gas at said second lambda probe 16 lies in the rich range below lambda=1. In the third regeneration phase 25, the burning off of the particles in said particle filter 15 is completed. Due to the lean operation of said internal combustion engine, a second section of the fifth lambda signal 65 of the first lambda probe 13 disposed upstream of said particle filter 15 lies in the lean range above lambda=1. Because the particles have been burned off and oxygen is no longer being consumed in said particle filter 15, the signal of said second lambda probe 16 disposed downstream of said particle filter 15 also lies in the lean range. For that reason, the second section of the sixth lambda signal 66 lies as the output signal of said second lambda probe 16 at a value above lambda=1 and is thereby congruent to said second section of the fifth lambda signal 65 within the scope of known tolerances. The end of the regeneration can therefore be determined if the output signal of said second lambda probe 16 corresponds to the output signal of said first lambda probe 13.

The burn-off of particles can be completely followed with lambda probes and it can be established to what extent said burn-off of particles has been completed and the regeneration phase can be ended. The method can be implemented with known wideband lambda probes, or even more cost effective two-point lambda probes can be used. In many cases, probes of this type are already being used in the exhaust gas duct 12 of the internal combustion engine 10 so that no additional cost and complexity are necessary. The method and the device are also especially suited for purifying the exhaust gas of Otto engines.

1. Method for monitoring and controlling the regeneration of a particle filter in an exhaust gas duct of an internal combustion engine, wherein said regeneration of the particle filter takes place by means of an oxidative burning off of particles during a regeneration phase, wherein during the regeneration phase of said particle filter the internal combustion engine is operated at a lean operating point at least intermittently during lean operating phases or during a mixture oscillation and in that the regeneration of said particle filter is monitored during the lean operating phases or during the mixture oscillation via the temporal course of a second signal of a second lambda probe disposed in the exhaust gas direction downstream of said particle filter or of a second parameter derived therefrom in comparison with the temporal course of a first signal of a first lambda probe disposed in the exhaust gas direction upstream of said particle filter or of a first parameter derived therefrom.

2. The method according to claim 1, wherein the regeneration phase of the particle filter is ended if during the lean operation phase or during the mixture oscillation the second signal of the second lambda probe corresponds to the first signal of the first lambda probe within a predetermined tolerance or if the second parameter derived from said second signal corresponds to the first parameter derived from said first signal within a predetermined tolerance.

3. The method according to claim 1, wherein the air/fuel mixture supplied to the internal combustion engine is changed periodically during the regeneration phase by means of the mixture oscillation such that an oxygen rich exhaust gas arises in the exhaust gas upstream of the particle filter.

4. The method according to claim 1, wherein the air/fuel mixture supplied to the internal combustion engine is changed periodically during the regeneration phase by means of the mixture oscillation such that a periodic change of lambda about the value: lambda=1 occurs in the exhaust gas upstream of the particle filter.

5. The method according to claim 1, wherein a lambda value of a first wideband lambda probe disposed upstream of the particle filter is used as the first signal and in that a second lambda value of a second wideband lambda probe disposed downstream of said particle filter or of a two-point lambda probe is used as the second signal.

6. The method according to claim 1, wherein a first probe voltage of a first two-point lambda probe disposed upstream of the particle filter is used as the first signal and in that a second probe voltage of a second two-point lambda probe disposed downstream of said particle filter is used as the second signal.

7. Device for monitoring and controlling the regeneration of a particle filter in an exhaust gas duct of an internal combustion engine, said regeneration of the particle filter occurring by means of an oxidative burning off of particles during a regeneration phase and the controlling of said regeneration of said particle filter taking place via a control unit, wherein a first lambda probe is disposed in the exhaust gas duct in the exhaust gas direction upstream of said particle filter and a second lambda probe is disposed in said exhaust gas duct in the exhaust gas direction downstream of said particle filter, in that a first signal of the first lambda probe and a second signal of the second lambda probe are supplied to the control unit and in that provision is made in said control unit for a first program routine for comparing the second signal or a second parameter derived therefrom with the first signal or a first parameter derived therefrom during lean operating phases provided in the regeneration phase or during a mixture oscillation of the internal combustion engine.

8. The device according to claim 7, wherein provision is made in the control unit for a second program routine for the mixture oscillation due to a periodic change in the fuel mixture supplied to the internal combustion engine during the regeneration phase.

9. Application of the method or the device according claim 1, for the regeneration of a particle filter provided in an exhaust gas duct of a diesel engine or an Otto engine.
